(19) United States
(12) Patent Application Publication
(10) Pub. No.: US 2022/0036161 A1
(43) Pub. Date: Feb. 3, 2022

(54) System and Method for Providing Real-Time Prediction of Time to Fatigue Failure Under Stochastic Loading

(71) Applicant: Massachusetts Institute of Technology, Cambridge, MA (US)

(72) Inventor: Maor Farid, Brighton, MA (US)

(21) Appl. No.: 16/941,841

(22) Filed: Jul. 29, 2020

(51) Int. Cl. G06N 3/04; G06N 3/08; G06K 9/62

(52) U.S. Cl. CPC G06N 3/0472; G06K 9/6256; G06N 3/08

(57) ABSTRACT

A prediction system predicts a failure time of a mechanical system of interest in real-time. A sensor/sensors array senses a characteristic of the mechanical system of interest. An artificial neural network system includes an artificial neural network (ANN), a training module (140) configured to train the ANN, and a real-time prediction module. Real-time data is recorded by the sensor/s and converted in real-time into an estimated failure time of the mechanical system of interest and a corresponding uncertainty quantification. A reporting module receives and displays the estimated failure time and the uncertainty quantification.

### FIELD OF THE INVENTION

The present invention relates to structural fatigue, and more particularly, is related to real-time prediction of time to fatigue failure under stochastic disturbances.

### BACKGROUND OF THE INVENTION

Stochastic oscillatory fatigue loading takes place in various mechanical systems, such as offshore and aerospace systems, automotive systems, and different mechanical components. Currently, cumulative fatigue failure is estimated using either time or frequency domain methods, where the frequency domain methods have previously been considered the most accurate and hence the most widely-used approach. However, despite the major engineering motivation, none of the existing methods reliably predicts the time remaining until failure.

The most widely used time domain approach is based on rainflow counting for decomposing the stochastic signal to its underlying amplitudes and their corresponding number of cycles, and applying Miner's rule to assess the resulting cumulative damage. Frequency domain method, for example, as described by Dirlik (T. Dirlik, “Application of computers in fatigue analysis,” University of Warwick, 1985) and Petrucci and Zuccarello (G. Petrucci and B. Zuccarello, “Fatigue life prediction under wide band random loading,” Fatigue Fract. Eng. Mater. Struct., vol. 27, no. 12, pp. 1183-1195, 2004), use probability density functions with parameters which are tuned with respect to rainflow counting and Miner's method.

Hence, due to multiple observatory studies, rainflow counting and Miner's rule are considered by many as more reliable and accurate with respect to the frequency domain methods. However, also the former is considered as inaccurate and limited in its ability to capture the underlying failure mechanism. For example, it is well known that sudden change in the loading amplitude leads to extensive cumulative damage which is overlooked by Miner's rule. Thus, disagreements between theoretical and experimental results have been extensively reported. Further, no close mathematical expression reliably ties a measured stochastic loading signal to an estimated time to failure in real-time, despite significant industrial and engineering importance of such a relation, since numerous engineering system undergo stochastic loading during their life-time, for example, aerial system, structures, machinery and more. Therefore, there is a need in the industry to address one or more of the abovementioned issues.

### SUMMARY OF THE INVENTION

Embodiments of the present invention provide a system and method for providing real-time prediction of time to fatigue failure under stochastic loading. Briefly described, the present invention is directed to a system that predicts a failure time of a mechanical system of interest in real-time. A sensor senses a characteristic of the mechanical system of interest. An artificial neural network system includes an artificial neural network (ANN), a training module (140) configured to train the ANN, and a real-time prediction module. Real-time data is from the sensor and converts the real-time data into an estimated failure time of the mechanical system of interest and a corresponding uncertainty quantification. A reporting module receives and displays the estimated failure time and the uncertainty quantification.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a block diagram of an exemplary embodiment system for providing real time prediction of failure from fatigue.

FIG. 2 is a block diagram illustrating further details of the exemplary embodiment system of FIG. 1.

FIG. 3A is a chart plotting a first snapshot of an exemplary loading signal against time and indicating a ground truth (GT) failure time, a predicted failure time, and an uncertainty gap.

FIG. 3B is a chart plotting a second snapshot of the exemplary loading signal against time and indicating the GT failure time, the predicted failure time, and the uncertainty gap.

FIG. 3C is a chart plotting the final snapshot of the exemplary loading signal against time (i.e. at the failure time instance) and indicating the GT failure time, the predicted failure time, and the uncertainty gap.

FIG. 4 is a flowchart of an exemplary embodiment of a method for determining the time to failure for a mechanical system under test.

FIG. 5 is a schematic diagram illustrating an example of a system for executing functionality of the present invention.

### DETAILED DESCRIPTION

The following definitions are useful for interpreting terms applied to features of the embodiments disclosed herein, and are meant only to define elements within the disclosure.

As used within this disclosure, “Fatigue failure” refers to malfunctioning of a system element due to weakening of the material due to oscillatory loading below its ultimate tensile strength. The failure results in localized and progressive mechanical damage and cracks growth. Fatigue damage is cumulative over time, and even though it can be assessed by non-destructive tests (NDT), it still can take place in unexpected timing, leading to hazardous consequences. Fatigue failure are one of the main reasons for mechanical failure in aerospace, offshore and machine components. Hence, estimation of the current cumulative fatigue damage and prediction of the time to failure of a given system, are of major importance.

As used within this disclosure, “time to failure” (TTF) refers to an estimated time interval before a catastrophic failure of a system element.

As used in this system, “disturbance” refers to any external loading/forcing applied to mechanical system of interest. For example, “periodic loading” refers to a periodic repetitive force applied to a system, and “stochastic loading” refers to a stochastic force applied to a system. A “loading signal” refers to the output/signal measured by a sensor as a result of applying a disturbance to the mechanical system of interest.

As used within this disclosure, a “quantified uncertainty measure” refers to a temporal window in which the failure might occur, rather than a fixed estimated time to failure.

As used within this disclosure, an “artificial neural network (ANN)” refers to a computing system made up of a number of simple, highly interconnected processing elements which process information by their dynamic state response to external inputs.

As used within this disclosure, “rainflow counting” refers to a method for reducing a measured stress signal into an equivalent set of simple stress reversals. Those reversals may be used as an input to subsequent processing, for example, the Miner's rule, in order to assess a damage fraction of the mechanical system under investigation, which provide an indication of closeness to failure.

As used within this disclosure a “critical location” refers to a portion of a mechanical system of interest either directly prone to failure or that experiences stresses/vibrations or the like that may contribute to failure of the mechanical system of interest.

Reference will now be made in detail to embodiments of the present invention, examples of which are illustrated in the accompanying drawings. Wherever possible, the same reference numbers are used in the drawings and the description to refer to the same or like parts.

Embodiments of the present invention provide systems and methods for a machine learning based approach to predict the time to failure of a given element based on real-time measurements and calculations. The embodiments provide rapid and up to date failure predictions. These embodiments incorporate pattern recognition abilities of artificial neural networks (ANNs), in a life-saving system that provides warnings regarding upcoming fatigue failures, without excessive complexity, cost and resources.

As described in the background section, fatigue damage under periodic loading has typically been estimated by time domain or frequency domain approaches. Moreover, none of the aforementioned approaches aims to predict the time to failure based under stochastic loading. In order to overcome this problem, embodiments of a machine-learning based system and method are provided, which include data acquisition, feature selection, model training, and real-time application for real-time prediction of the TTF with additional uncertainty measure that provides a time-slot during which a failure might accrue.

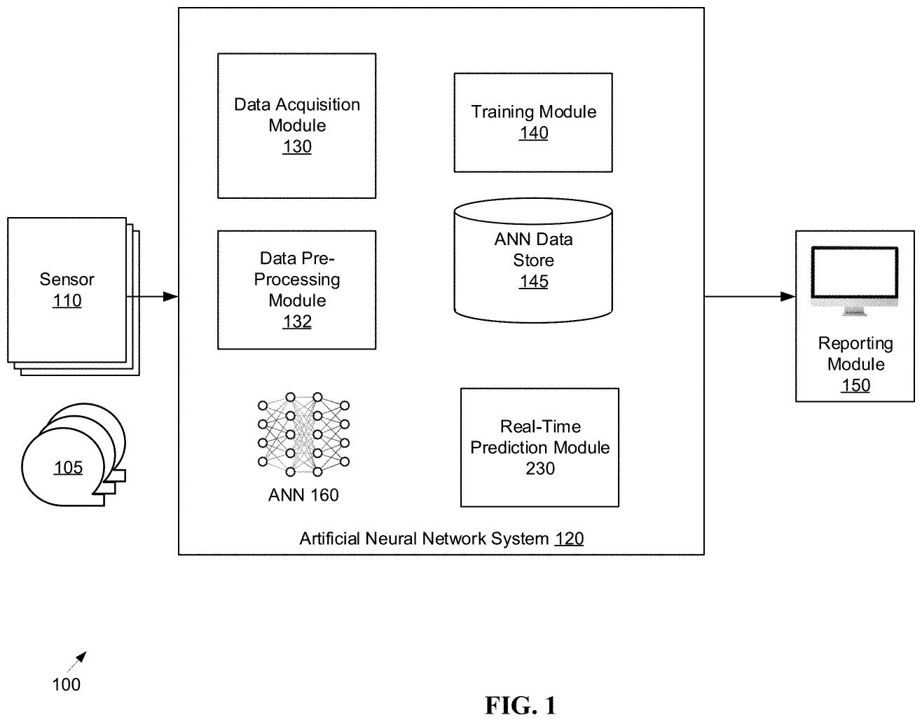

The embodiments herein disclose a method and system for predicting time to fatigue failure and the corresponding uncertainty gap under broad-band stochastic loading using artificial neural networks (ANNs). FIG. 1 is a block diagram of an exemplary embodiment system 100 for providing real time prediction of failure from fatigue. One or more sensors 110, for example, an array of sensors, is installed at critical locations of a mechanical system of interest 105. The one or more sensors 110 monitor vibrational data (stress, strain, acceleration, etc.) in the form of stochastic time series, which is provided in real time, for example, via a signal to an ANN system 120 with a pre-trained ANN 160 which predicts a remaining time to failure and a corresponding uncertainty time gap associated with the predicted time to failure. The ANN system 120 provides the predicted remaining time to failure and uncertainty time gap to a reporting module 150.

One or more sensors 110 are in contact with the element under test (not shown), for example, the wing of an aircraft or the support of a bridge, among other possible elements. The one or more sensors 110 may detect various physical properties of the element under test, for example, stress, strain, acceleration, among others. The sensors 110 provide data to the ANN system 120, for example, by a direct electrical connection, or via a communication network (not shown).

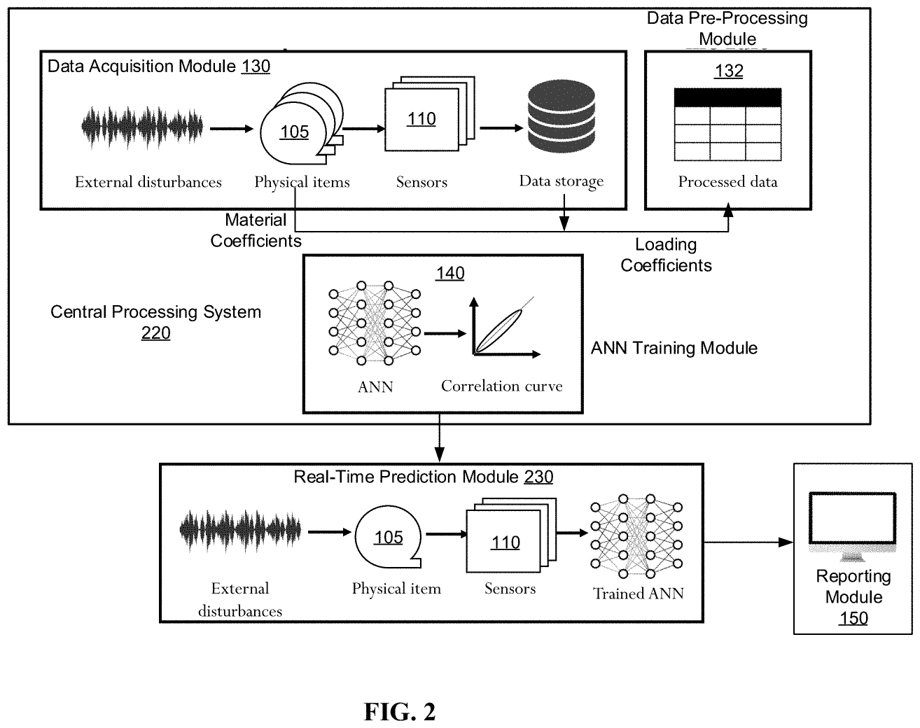

FIG. 2 shows the ANN system in greater detail. The ANN system 120 includes a training module 140, which is in communication with a data store 145. For example, the data store 145 may store ANN weights. During the pre-processing stage 132, the measured signals are transformed to their corresponding loading coefficients, and the material coeffects associated with the physical items are obtained. Then, during the training process, the ANN 160 is trained on a data set of the aforementioned coefficients, for example, measured from similar mechanical systems and experiencing external disturbances which correspond to the same power spectral density (PSD), i.e. share the same frequency content expected for the system under test.

In general, during the training stage, the ANN training module 140 feeds the ANN 160 with experimental data taken elements similar to the mechanical system of interest 105 under operational scenarios similar to the real operation of the mechanical system of interest 105, i.e. the sensors 110 are located in similar locations on similar items in terms of system characteristics (geometry, boundary conditions, material) as the mechanical system of interest 105. Then the experimental data (time histories of stress, strain, or acceleration, among others) are preprocessed to a tabular dataset which includes the mean, 90^{th} percentile value of the time series, and three fatigue parameters A, b and σᵤₜₛ. During the training processes, the ANN training module 140 modifies internal parameters of the ANN 160, for example, weights and biases, which essentially define the highly-nonlinear and high-dimensional function that maps between the input data from the sensors 110 and the time to failure, reported by the reporting module 150.

The embodiments provide ANN-based approach for TTF prediction of the mechanical system of interest 105 under statistically stationary stochastic loading. The system and method may be tuned to operate upon a wide range of possible material properties and loading characteristics of the mechanical system of interest 105, for example by training the ANN 160 on a proper range of disturbances (captured by learned coefficients related to a known disturbance) and items designs (captured by the material coefficients). Both the disturbance coefficients and the material coefficients serve as an input to the ANN. The effectivity range of the ANN 160 is defined by the richness of the dataset-generally, the ANN 160 gives good TTF predictions for cases which are well-represented in the dataset. The embodiments leverage the generalization properties of an ANN to provide relevant predictions for a wide range of materials and loading characteristics. Moreover, embodiments provide a quantified uncertainty measure, describing the tolerance gap in indicating an actual TTF for the element being monitored. The uncertainty measure is defined later from a correlation curve, described further below.

The Miner's linear cumulative damage rule is given by the following Eq. 1,

$$D = {\sum }_{i = 1}^{{N}_{k}} \frac{{n}_{i}}{{N}_{f , i}} \qquad ( Eq . 1 )$$

where D is the damage fraction which quantifies the cumulative damage and the closeness to fatigue failure which corresponds to D=1. The failure time, which is denoted be τ, fulfils the following relation: D(τ)=1. Value nᵢ is the cycles number of the i^{th} amplitude S_{a,i} obtained by the rainflow counting method. Nₖ is a user-defined hyper-parameter describing the number of amplitudes to which the signal is decomposed to. N_{f,i} is the maximal cycles number of amplitudes Sᵢ which leads to fatigue failure, and it is obtained by the following relation:

$$\begin{matrix}{N}_{f , i} = {( \frac{Sa , i}{A α} )}^{\frac{1}{b}} & ( Eq . 2 ) \\ α = 1 - \frac{{S}_{m}}{{σ}_{uts}} & ( Eq . 3 )\end{matrix}$$

Here A and b are the fatigue strength and fatigue exponent for the element under test. For example, A and b may be obtained from literature or by a preliminary experiment. Parameter a is the Goodman's correction factor for non-zero mean stress, and σᵤₜₛ is the ultimate tensile strength of the material. It is noteworthy that the failure time and the behavior of an element subjected to periodic loading is highly dependent on its material properties.

Fatigue damage is not a time-dependent phenomenon, in that fatigue damage is not dictated by the frequency content of the loading signal, but only the amplitudes of its Fourier components. However, previous works pointed out that phenomena associated with rapid changes in time of the loading, such as sudden gradients in the amplitude of the loading signal, have a non-negligible effect on the cumulative damage, which is not captured by any time-domain method.

The loading signal is generated from a given power spectral density (PSD) function G(f), describing the frequency content of the loading. Then, N_{f} frequencies are generated from the PSD frequency range, to yield the following loading signal:

S(t)=Sₘ+Σᵢ₌₁^{N}^{_{f}}\sqrt{2G(fᵢ)Δf} cos(2πfᵢt+ϕᵢ) (Eq. 4)

Here, ϕᵢ are random phase angles distributed uniformly between 0 to 2π, i.e. ϕᵢ˜[0,2π]. Sₘ is a random variable describing the mean loading amplitude, which is uniformly distributed between zero and 250, i.e. Sₘ˜ [0,250].

For example, the frequency range may be in f˜[100,200]Hz, with a sampling rate of ten times the Nyquist frequency (fₛ=2000 Hz). The number of frequencies composing the loading signals was chosen as N_{f}=20, and the number of amplitudes in the rainflow counting method was chosen as Nₖ=100. The simulations were computed up to time t_{f}=120 with time step of Δt=1/fₛ=0.0005. The PSD function G(f) is chosen as a Gaussian distribution described by the following equation:

$$G ( f ) = {A}_{G} exp \frac{{( f - {μ}_{G} )}^{2}}{2 {σ}_{G}^{2}}$$

Where, the PSD parameters are chosen as μ_{G}=150, σ_{G}=175, and A_{G}=180. The magnitude of the PSD function A_{G} was chosen such that the maximal amplitude of the loading signal will not accede 85% of the ultimate tensile strength σᵤₜₛ of the material, in order to avoid ultra-low cycle fatigue failures. Then, a data-set of N=2000 loading series are produced according to the equations above, and their corresponding failure time τ is computed numerically according to rainflow counting and Miner's rule. The dataset is divided to train and test sets, with division ratio of 75:25, i.e. Nₜᵣ=1500, Nₜₑ=500.

It is noteworthy, that an ANN trained on failure model of rainflow counting procedure and Miner's rule does not leads to any loss of generality, because the ANN can be trained on any available dataset and capture the underlying relations between the systems features and the resulting time to failure. The same explanation holds for Gaussian PSD.

The ANN system 120 predicts failure of mechanical system of interest 105 in real time. Three material coefficients are known in advance, and two loading coefficients Sₘ and Sₚ are calculated in real-time from the measured loading signal, where Sₘ is the mean of the measured signal and Sₚ is the p^{th} percentile of the signal, i.e. the peak value which is greater that p % of all the other peaks of the measured signal. All five features (the three material coefficients and the two loading coefficients) are injected into the ANN 160 in a desired frequency, and the predicted failure time and the associated uncertainly boundaries are produced. Then, the time to failure is derived directly. Thus, under the assumption of statistically-stationary stochastic loading, the failure time can be predicted in real-time during loading and obtain warnings from failure sufficiently before failure occurrence.

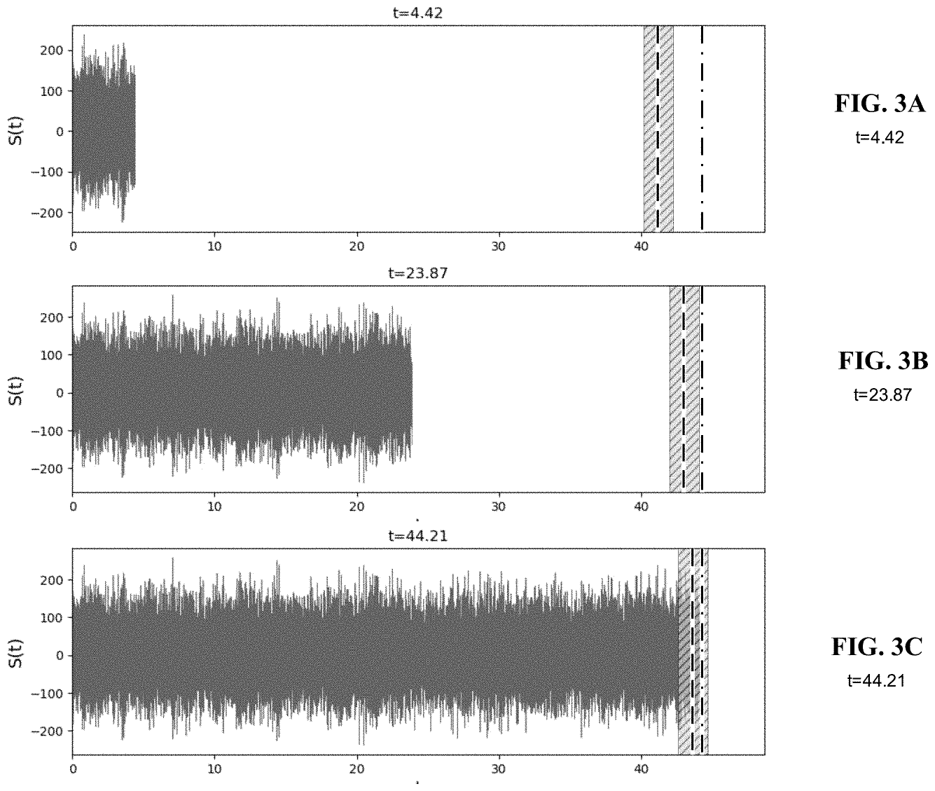

FIGS. 3A-3C are each charts plotting an in-progress loading signal against time and indicating the GT failure time, the predicted failure time, and the uncertainty gap. The plots indicate the measured loading signal (solid), the GT failure time (dash-dot), the predicted failure time (dashed), and the uncertainty gaps (diagonal hash), over times of 4.42 seconds, 23.87 seconds, and 44.21 seconds, respectively.

The above described embodiments illustrate ANN-based approach for both offline and real-time failure time prediction. The prediction obtained by the machine learning model is based on the material properties of the elements and the mean amplitude and the percentile amplitude of the measured loading. The embodiments assume that the element is subjected to a statistically-stationary loading. In addition to the predicted failure time, an uncertainty measure is obtained based on the tested performances of the model.

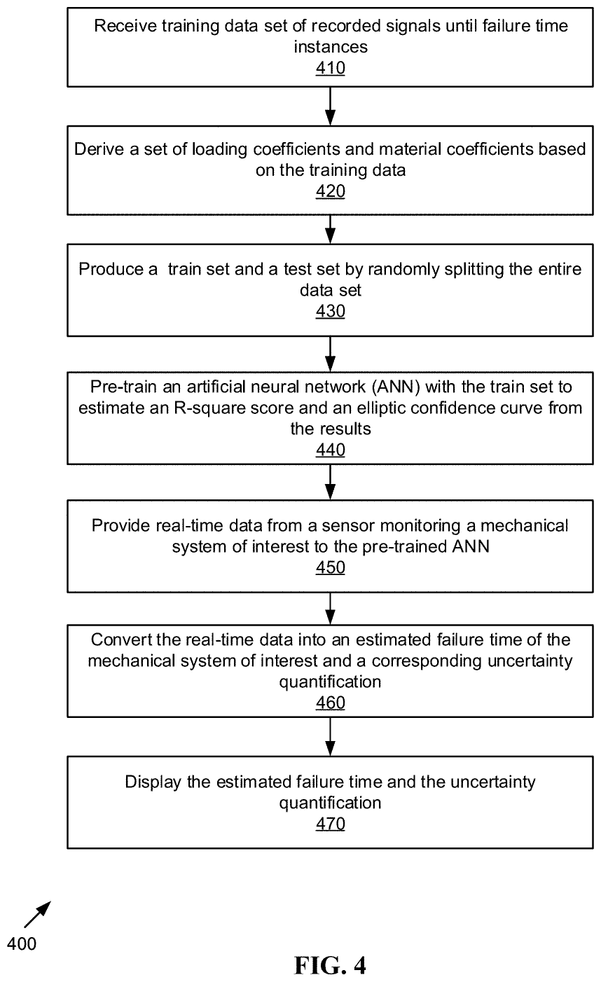

FIG. 4 is a flowchart of an exemplary embodiment of a method for determining the time to failure for a mechanical system under test. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

The method is described with reference to the five distinct conceptual modules shown in FIG. 2 which are connected in sequential fashion: the data acquisition module 130, the data pre-processing module 132, the training module 140, a real-time prediction module 230, and the reporting module 150. Under the embodiments described herein, the data acquisition module 130, the data pre-processing module 132, and the training module 140, are included in a central processing system 220. For example, the central processing system 220 may be located remotely from the of mechanical system of interest 105, communicating via a wired or wireless communication network. The real-time prediction module 230 may be part of an embedded processing system located in proximity of the mechanical system of interest 105 and the reporting module 150 may be implemented as a display system, for example within the view of an operator of the mechanical system of interest 105. The central processing system 220 and the embedded processing system generally contain both software components and hardware platform. In alternative embodiments, the modules 130, 132, 140, 230, 150 may be grouped and or distributed differently than the embodiment depicted herein.

A training data set of recorded signals of failure time instances is received, as shown by block 410, for example by the data acquisition module 130. For example, a plurality of experiments is executed that produce a loading signal that provides a data set of time series and times of failure (TFs). The tested items/components (mechanical systems, machinery components, structures, etc.) are of various material coefficients (A, b, σᵤₜₛ) loaded by different stochastic loadings.

A set of loading coefficients and material coefficients are derived based on the training data, as shown by block 420. For a time-history associated with each of the experiments, the data pre-processing module 132 calculates two sets of loading coefficients of the measured signal: the mean value and the 90^{th} percentile. The 90^{th} percentile loading coefficients include the peak values greater than 90% of all the other peak values in the loading signal. The loading coefficients and the corresponding three material coefficients are organized in a data structure, for example in tabular form, in which each row corresponds to a single experiment. The data is based upon, for example, one or more experiments, computational analysis (i.e. finite element simulations), and/or empirical methods, such as rainflow cycle counting algorithm combined with Miner's rule.

The training module 140 accesses the loading coefficients and material coefficients from the data pre-processing module 132. Table 1 presents a set of exemplary samples from the data pre-processing module 132.

This data from the data pre-processing module 132 is then randomly divided into two portions with proportion of 70%-30%, as shown by block 430. The first portion is used to train the ANN 160, such that by processing this data the ANN 160 is able to obtain approximate correlation/mapping between the input data and the corresponding output. The second portion which is called the test-set, is used to test the obtained mapping of the ANN 160. This is made by inputting the test-set into the ANN 160 and comparing the output predicted by the ANN 160 and the corresponding true output. The train set is used to train the ANN 160, and the test set is used to validate the performance of the ANN 160. The data from the train set is fed into the ANN 160 that learns the relation (or mapping) between the input parameters and the corresponding time to failure, as shown by block 440. During the training process, the ANN parameters, i.e. weights and biases, are tuned to yield a proper mapping between the given input and output. The ANN tuning process is performed with the help of a backpropagartion numerical algorithm (see Chauvin, Yves, and David E. Rumelhart, eds. Backpropagation: theory, architectures, and applications. Psychology press, 1995), in which the weights and biases of the ANN are corrected iteratively in order to minimize a chosen loss function that describes the learning performances of the ANN. For accurate prediction, the loss function has a low value, and the backpropagation algorithm performs only minor corrections to the weights and biases of the ANN. In contrast, for bad predictions, the loss function has a high value and the backpropagation algorithm performs major corrections to the weights and biases of the ANN.

The training module 140 plots the ground truth (GT) failure times (FTs) are versus the predicted FTs on a single plot referred to as the correlation curve. Each experiment is represented by a single dot on the plot, and all the experiments are represented by a point cloud. A linear curve is fitted to the data using least-squares method. For a sufficient training processes the slope (R-square score) of the curve equates approximately to unity. Then, an elliptic confidence curve is fitted to the point cloud, corresponding to Mahalanobis distance of 3.0. The internal area of the eliptic curve is called the confidence region.

Real-time data from a sensor monitoring a mechanical system of interest 105 is provided to the pre-trained ANN 160, as shown by block 450. The Real-time prediction module 230 uses the pre-trained ANN 160 to convert the real-time data into an estimated failure time and its corresponding uncertainty quantification (UQ), as shown by block 460. The sensors 110 produce vibrational data which are converted to the two aforementioned loading parameters (the mean value and the 90^{th} percentile), which, together with the three material coefficients are transferred into the trained ANN 160 which outputs the predicted TTF and the associated UQ to the reporting module 150. The UQ is determined according to the predicted TF in the following way: the upper and lower bounds of the predicted TF are the two values of the elliptic confidence curve which correspond to the predicted TF value in the correlation curve. Hence, the UQ is as follows: UQ(τ_{pred})=[E⁻(τ_{pred}), E⁺(τ_{pred})], where τ_{pred} is the predated TF, and E⁻(τ_{pred}), E⁺(τ_{pred}) are its corresponding lower an upper valued of the elliptic confidence curve. Both the TF and the UQ are transferred to the display module 150 for user display, as shown by block 470, so the user may take responsive measures regarding.

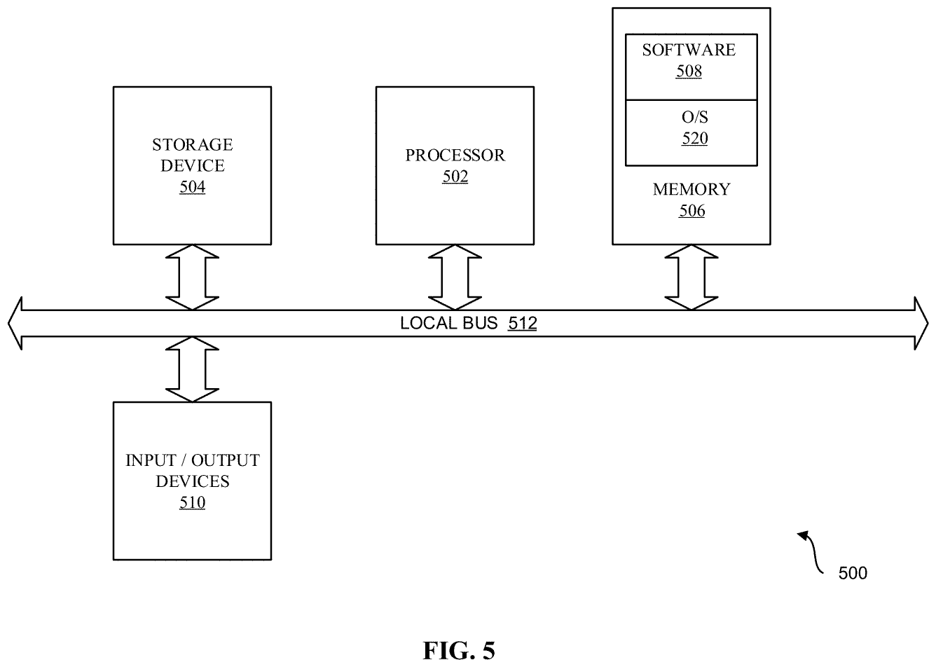

The present system for executing the functionality of the abovementioned modules described in detail above may be a computer, an example of which is shown in the schematic diagram of FIG. 5. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 and/or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The method and system embodiments described above may be implemented as a commercial real-time predictive system, which is based on a real-time measured loading signal by a strain-gauge located in the element's critical location. This system can give valuable warning and operational suggestions and by that to serve as a lifesaving system. Examples of applications for such systems include (but are not limited to):
Aerial systems
Machinery with rotating elements
Earthquakes
Vehicle accidents, and more.
   It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for predicting failure time of a mechanical system of interest in real-time, comprising the steps of:
a sensor configured to sense a characteristic of the mechanical system of interest;
an artificial neural network system (120) comprising:
a processor and a data store (145) configured to provide non-transitory instructions to the processor, which when executed by the processor provide:
an artificial neural network (160);
a training module (140) configured to train the artificial neural network; and
a real-time prediction module (230), configured to:
receive real-time data from the sensor; and
convert the real-time data into an estimated failure time of the mechanical system of interest and a corresponding uncertainty quantification; and
a reporting module configured to receive and display the estimated failure time and the uncertainty quantification.

2. The system of claim 1, wherein the artificial neural network system (120) further comprises:
a data acquisition module (130) configured to receive a training data set;
a data pre-processing module (132) configured to:
derive a set of loading coefficients and material coefficients based on the training data set; and
produce a train set and a test set derived from the loading coefficients and material coefficients.

3. The system of claim 2, wherein the training module is further configured to pre-training the artificial neural network with the train set to estimate an R-square score and an elliptic confidence curve.

4. The system of claim 2, wherein a ratio of the train set to the test set is greater than 2:1.

5. The system of claim 2, wherein the ratio of the train set to the test set is on the order of 70:30.

6. The system of claim 1, wherein the reporting module further comprises a display.

7. A computer based method for predicting failure time of a mechanical system of interest in real-time, comprising the steps of:
receiving a training data set;
deriving a set of loading coefficients and material coefficients based on the training data set;
producing a train set and a test set derived from the loading coefficients and material coefficients;
pre-training an artificial neural network with the train set to estimate an R-square score and an elliptic confidence curve;
providing real-time data from a sensor monitoring a mechanical system of interest to the pre-trained ANN;
converting the real-time data into an estimated failure time of the mechanical system of interest and a corresponding uncertainty quantification; and
displaying the estimated failure time and the uncertainty quantification.

8. The method of claim 7, wherein the training module is further configured to pre-training the artificial neural network with the train set to estimate an R-square score and an elliptic confidence curve.

9. The system of claim 7, wherein a ratio of the train set to the test set is greater than 2:1.

10. The method of claim 7, wherein the ratio of the train set to the test set is on the order of 70:30.

11. The system of claim 7, wherein the reporting module further comprises a display.
